(19) United States
(12) Patent Application Publication
(10) Pub. No.: US 2024/0298404 A1
(43) Pub. Date: Sep. 5, 2024

(54) Arrangement for Determining a Printed Circuit Board Identifier

(71) Applicant: Siemens Aktiengesellschaft, Muenchen (DE)

(72) Inventors: Martin MATSCHNIG, Tulln (AT); Thomas HINTERSTOISSER, Bisamberg (AT); Bernhard FISCHER, Wolkersdorf im Weinviertel (AT); Wilhelm MEYRATH, Wien, (AT); Herbert TAUCHER, Wien (AT)

(21) Appl. No.: 18/278,560

(22) PCT Filed: Feb. 24, 2022
(86) PCT No.: PCT/EP2022/054693

§ 371 Date: Aug. 23, 2023

(30) Foreign Application Priority Data
Feb. 25, 2021 (EP) 21159317

(51) Int. Cl. H05K 1/02; G06F 21/73; H05K 1/16

(52) U.S. Cl. CPC H05K 1/0298; G06F 21/73; H05K 1/162; H05K 2201/10181

(57) ABSTRACT

An arrangement for determining a unique printed circuit board identifier includes at least one PUF unit having ring oscillators which determines a printed circuit board (PCB) identifier based on ring oscillator frequencies and is arranged in an electronic component and includes delay elements on the PCB, where oscillator loops of ring oscillators of the PUF unit is formed from delay elements that are formed as strip conductors on the PCB and each have first portions on a first conductive layer of the PCB and each have second portions on a second conductive layer of the PCB, where electrical connections between the first and second portions of delay elements are made via electrical through-connections, and where two delay elements are each arranged on the PCB such that the first portions of two respective delay elements overlap with the respective second portions of the two delay elements at at least one point.

### CROSS-REFERENCE TO RELATED APPLICATIONS

This is a U.S. national stage of application No. PCT/EP2022/054693 filed 24 Feb. 2022. Priority is claimed on European Application No. 21159317.3 filed 25 Feb. 2021, the content of which is incorporated herein by reference in its entirety.

### BACKGROUND OF THE INVENTION

### 1. Field of the Invention

The present invention relates generally relates to the field of electronic components or integrated circuits and, in particular, application-specific integrated circuits (ASICs) and relates, more specifically, to an arrangement for determining a unique printed circuit board identifier, via which an electronic component which is fitted to a printed circuit board, in particular an application-specific integrated circuit (ASIC), is uniquely linked to the printed circuit board, where the arrangement comprises at least one physical unclonable functions (PUF) unit having ring oscillators which, by reference to ring oscillator frequencies, determines the unique printed circuit board identifier, and is arranged in the electronic component. The arrangement further comprises delay elements, which are fitted to the printed circuit board, and in each case, an oscillator loop of a respective ring oscillator of the PUF unit is formed from a delay element.

### 2. Description of the Related Art

Integrated circuits (ICs), such as application-specific integrated circuits (ASICs), field programmable gate arrays (FPGAs) or a “system-on-chip” (SoC) are electronic components that are employed nowadays in numerous electrical and/or electronic devices or systems, e.g., in programmable logic controllers (PLCs), graphics processors, or in cryptographic algorithms in computer systems. Nowadays, with the use of electronic components that are configured as integrated circuits, via a corresponding design and configuration, a wide variety of logic circuits and functions in electrical devices can be formed. These range from simple counters or interfaces for digital modules through to highly complex circuits, such as microcontrollers, and/or memory controllers.

For the construction of electrical devices, integrated circuits configured in the form of electronic components, such as ASICs, together with further components (e.g., resistors, coils, capacitors, heatsinks, diodes, and/or transistors) are fitted to circuit boards or “printed circuit boards” (PCBs). Printed circuit boards are employed, firstly, for mechanical attachment and, secondly to electrically connect integrated circuits and further components. They are comprised of an electrically insulating material, having conductive connections that are bonded thereto (the printed conductors) that are generally etched from a thin layer of copper. Components of the electrical device are generally fitted to solder pads or soldering eyelets. In order to accommodate a high component density, particularly in the case of surface-mounted-device (SMD) components, printed circuit boards can at least comprise conductive connections on both sides, or can be configured with a multi-layered structure. Connections between the individual conductive layers or conductor layers of the printed circuit board are formed via through-contacts or “vias”. Moreover, simple passive components such as resistors, inductances, and/or small capacitors, can be integrated in the printed circuit board.

Particularly in complex electronic devices and systems, such as programmable logic controllers, processors, and/or graphics cards, the industry is now encountering rising cases of product or hardware counterfeiting. Various approaches to hardware counterfeiting can be observed. Thus, for example, electronic components, in particular ASIC components, are removed or desoldered from defective electronic devices and fitted directly to new printed circuit boards, e.g., in order to reproduce an electronic device or an original hardware. At unsecure points in supply chains for the manufacture of electronic devices, it is also possible, for example, for original components or original ASICs to be misappropriated and/or unwarily discarded, and thus to appear in the printed circuit boards of third party providers or in counterfeit hardware products. In particular, this can affect very large manufacturers who require a multiplicity of populated printed circuit boards for their daily operations, and for whom it can be very difficult to ensure 100% security of their supply chain. A further possibility for the employment of an electronic component, such as an ASIC, in hardware counterfeiting can occur, for example, where new or reused electronic components are brought into service, e.g., in a laboratory environment, and are then analyzed, and optionally copied and/or manipulated, via “reverse engineering”.

In the production sector for integrated circuits or electronic components, and for electronic devices, the issue of hardware counterfeiting has been known for some time. Consequently, a number of approaches and methods have already been proposed and developed in the interests of alleviating the problem of hardware counterfeiting and confirming the integrity of a printed circuit board to which an electronic component is fitted, and/or of the authenticity of an electronic device.

From the document “Hamlet, J. et al.; “Unique Signature from Printed Circuit Board Design Pattern and Surface Mount Passives”, IEEE, International Carnahan Conference on Security Technology (ICCST), Madrid, 2017”, for example, a method is known where production-specific properties of printed circuit boards, in combination with simple passive components that are fitted to the respective printed circuit board (e.g., resistors, and/or capacitors), or in combination with the structures of conductor patterns that are applied to the respective printed circuit board, are employed for the generation of unique identifiers for individual printed circuit boards. The printed circuit board signature or identifier thus generated that can then be employed in integrity and authentication checks, has a disadvantage, because the fitting of additional components and/or structures to the printed circuit board is required to generate the unique printed circuit board identifier.

A further method for the anti-counterfeit protection of hardware is known, for example, from the document “Hennessy et al., “JTAG-Based Robust PCB Authentication for Protection Against Counterfeiting Attacks”, 2016, 21^{st} Asia and South Pacific Design Automation Conference (ASP-DAC), Macau, 2016, pp. 56-61”. Herein, “boundary scan chain architecture” (BSA), based upon Joint Test Action Group (JTAG) or IEEE Standard 1149.1, is employed, via which a methodology for the testing and debugging of integrated circuits, i.e., of electronic components fitted to printed circuit boards, is described, and integrated circuits or electronic components can be functionally tested whilst already located in their working environment (e.g. soldered in place on the printed circuit board). According to the method proposed here, delays on the JTAG paths between electronic components or printed circuits are measured, and a unique identifier for the printed circuit board is inferred herefrom. The printed circuit board identifier is generated by the manufacturer, and is then saved in a central database. A customer (in the event of any suspicion) can generate an identifier for the circuit board by the same method, and compare the generated identifier with the printed circuit board identifier or signature that is saved in the central data base. In order to confirm any counterfeiting, however, access to the central data base, or to the printed circuit board identifiers that are saved therein is required.

From the document “Wie et al., “BoardPUF: Physical Unclonable Functions for printed circuit board authentication,” 2015 IEEE/ACM International Conference on Computer-Aided Design (ICCAD), Austin, T X, 2015, pp. 152-158”, a further approach is known, via which integrated circuits that are fitted to printed circuit boards can be protected against counterfeiting and/or against illegitimate use or reuse. For the generation of a printed circuit board-specific identifier, the concept of physical unclonable functions (PUFs) is employed.

PUFs, in different embodiments, are known, for example, from the document “Maes, R.; Verbauwhede, I. (2010); “Physically Unclonable Functions: A Study on the State of the Art and Future Research Directions”, In: Sadeghi A R., Naccache D. (eds) Towards Hardware-Intrinsic Security. Information Security and Cryptography; Springer, Berlin, Heidelberg”. PUF units are employed for the reliable identification of objects by reference to their intrinsic physical properties. A physical property of an object is thus employed as an individual fingerprint, in order to confirm the integrity and authenticity of the object. To this end, an input or “challenge” is applied to a PUF unit, the input is processed by the application of a known method (function), and a resulting return value (response) is generated which, in the event of any duplication or counterfeiting of the electronic device, cannot be generated by the application of the same challenge.

In the above-mentioned document by Wei et al., a “ring oscillator PUF unit” is employed, in which feedback from ring oscillators is generated with time delays, which are applied, e.g., to an input of a selector circuit or a multiplexer. An oscillation period or the respective ring oscillator frequency, in turn, is dependent upon small manufacturing tolerances, and is specific to the PUF unit. The return value, for example, is established by a comparison of the frequencies of ring oscillators in the PUF unit, or by a read-out from the multiplexer at a specific time point. In the case of the ring oscillator PUF unit that is employed for the generation of a unique printed circuit board signature, the oscillator chain of the integrated circuit is expanded by the inclusion of capacitances that are external to the electronic component in the form of an oscillator loop. However, capacitances are not fitted to the printed circuit board as discrete components, but are directly embedded as capacitance units in the metal layers of the printed circuit board. One capacitance unit is thus assigned to each ring oscillator, via a delay element. This method also has an associated disadvantage, because it is necessary for embedded capacitance units to be considered at the printed circuit board design stage, or in the production stage, via “on-board” elements. Complexity and costs associated with the manufacture of the printed circuit board and the electronic component are increased, as a result. Moreover, thermal effects in the printed circuit board (e.g. differential heat-up) associated with the operation of the electrical device can potentially generate variations in the respective time delay of the respective capacitance unit, and thus variations in the frequency of the respective ring oscillator. This can result in variations in the printed circuit board identifier established and thus, potentially, in malfunctions of the electronic component, if the identifier has been established in an incorrect manner.

### SUMMARY OF THE INVENTION

In view of the foregoing, it is therefore an object of the invention to provide an arrangement for determining a unique printed circuit board identifier, which represents an improvement over the prior art, and via which, in a simple manner, with no malfunctions or additional costs, an electronic component can be uniquely linked to a printed circuit board to which the electronic component is fitted.

This and other objects and advantages are achieved in accordance with the invention by an arrangement for determining a unique printed circuit board identifier, via which an electronic component that is fitted to a printed circuit board is uniquely linked to the printed circuit board. The arrangement thus comprises at least one PUF unit having ring oscillators, which determines the printed circuit board identifier by reference to ring oscillator frequencies and is arranged in the electronic component, and delay elements, which are fitted to the printed circuit board. An oscillator loop of a ring oscillator of the PUF unit is formed by one delay element in each case. Moreover, the delay elements are configured in the form of printed conductors that are routed on the printed circuit board. Each delay element comprises first sections that are routed on a first conductive layer of the printed circuit board, and second sections that are routed on a second conductive layer of the printed circuit board, where the first sections of the respective delay element that are routed on the first conductive layer of the printed circuit board and the second sections of the respective delay element that are routed on the second conductive layer of the printed circuit board are connected via electrical through-contacts. Moreover, two delay elements in are each arranged or combined on the printed circuit board, such that, at at least one point, the respective first sections of the two respective delay elements overlap intersect with the or respective second sections of the two respective delay elements where, at the at least one overlap point or region between the two respective delay elements, no electrically conductive connection or no electrically conductive contact is in place.

A main aspect of the proposed solution in accordance with the invention is provided in that, via a specific arrangement of each of the two delay elements, which are responsible for a printed circuit board-specific frequency control of the respective ring oscillator of the PUF unit, on the printed circuit board, a twisted printed conductor pair is formed on the printed circuit board. The printed conductor sections of the two respective delay elements that are routed, in an alternating manner, on a first conductive layer and a second conductive layer overlap or intersect at at least one point, but assume no mutual electrical contact. With the symmetrical arrangement and these overlap points of two respective delay elements, thermal compensation is achieved. This permits the achievement of thermal stability over a relatively large temperature range for the determination of a printed circuit board identifier via a PUF unit, as a result of which a printed circuit board identifier can be determined during the routine operation of an electrical device or an electronic component in a substantially error-free manner.

The changeover from the first to the second, or from the second to the first conductive layer along the profile of the respective delay element is executed via electrical through-contacts which, in particular, form a primary source for a measure of the information content or entropy for the PUF unit, by which the respective ring oscillator frequency of the respective delay element is influenced in a printed circuit board-specific manner. The arrangement thus provides sufficient variance in different printed circuit boards for the prevention, e.g., of counterfeiting or attempted the reverse engineering of electronic components that have been dismantled or removed from an original circuit board, in a simple manner. Even if the dismantled or removed electronic component is refitted, for example, to the same printed circuit board, a difference in the conductivity, e.g., of newly formed soldered connections or a minimal displacement of the electronic component on the printed circuit board can result in an alteration to the printed circuit board identifier such that, e.g., upon comparison with an originally determined printed circuit board identifier, any entry into service of the electronic component is prevented.

Moreover, this arrangement, via delay elements that are configured as printed conductors having a specific layout on the printed circuit board, permits a cost-effective and simply executable anti-counterfeit protection for electronic components, such as ASICs, without the employment of additional components or hardware elements on the printed circuit board. It is further advantageous if the electrical through-contacts that are respectively employed by two delay elements are arranged adjacently on the printed circuit board. As a result, for example, the respective first sections of the respective two delay elements and the respective second sections of the respective two delay elements can be configured, e.g., in a mutually parallel arrangement, and thus arranged on the respective conductive layer of the printed circuit board in a space-saving manner.

Advantageously, the arrangement is configured, during a linking phase, to determine and permanently save the printed circuit board identifier in the electronic component. Permanent saving in the component is achieved, e.g., via an “eFuse”. The linking phase can be executed, e.g., in conjunction with an initial switch-on, for example, in conjunction with an initial “power-on reset” of the electronic component or integrated circuit, and can be executed in a trusted environment, e.g., on the premises of the manufacturer, o the like. The electronic component is thus securely linked, in a simple manner, to the original printed circuit board employed.

Ideally, the arrangement is further configured such that the printed circuit board identifier is generated in a repeated manner during the routine operation of the electronic component. The arrangement can, for example, in conjunction with each switch-on and/or run-up of the component or integrated circuit (e.g., at each power-on reset), execute a further determination of the printed circuit board identifier. Moreover, the arrangement is also configured such that the printed circuit board identifier generated during routine operation is compared with the printed circuit board identifier generated during the linking phase, which is permanently saved in the component. Depending upon the matching or otherwise of the two printed circuit board identifiers, the switch-on and/or run-up of the electronic component can be continued or interrupted. As a result, any attempts at the “reverse engineering” of the electronic component and/or counterfeiting of the component can be prevented in a highly effective manner.

In accordance with an appropriate further embodiment of the invention, the arrangement comprises a memory unit, in which the printed circuit board identifier is permanently saved during the linking phase. The memory unit is arranged, for example, in the electronic component. The memory unit can ideally be configured to be activatable for the permanent saving of the printed circuit board identifier. This means that the linking phase, or the permanent saving of the printed circuit board identifier, is only executed once the memory unit has been activated for this purpose. As a result, an initial switch-on and testing of the electronic component or integrated circuit can be executed, for example, by the manufacturer, without the execution of the linking phase or the permanent saving of the printed circuit board identifier in the memory unit, e.g., during a test phase.

Ideally, the arrangement is configured such that activation of the memory unit for the permanent saving of the printed circuit board identifier is executed via a test interface. As a result, the memory unit can be activated in a highly simple manner. At the next switch-on or power-on reset, the linking phase is then executed, or the printed circuit board identifier thus determined is permanently written in the memory unit on a one-off basis. As a test interface for activating the storage unit, e.g., a JTAG interface can be employed. JTAG stands for “Joint Test Action Group” or Institute of Electrical and Electronics Engineers (IEEE) Standard 1149.1, under the terms of which a methodology is described for testing and debugging integrated circuits, i.e., electronic components fitted to printed circuit boards, and functional testing integrated circuits or electronic components. In accordance with an embodiment of the invention, the memory unit is configured in the form of an arrangement of in-component fuse link wires. This arrangement of fuse link wires forms an arrangement of safety elements in the electronic component which, e.g., during a test phase, is deactivated and which can be activated in a highly simple manner, e.g., via a test interface, further to the completion of the test phase. Once the arrangement of fuse link wires is activated, in the linking phase, e.g., by a corresponding fusion of fuse link wires, the printed circuit board identifier can be burned-in to the electronic component in a permanent and relatively counterfeit-proof manner.

The electronic component is preferably formed as an “application-specific integrated circuit” or ASIC.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in an exemplary manner hereinafter, with reference to the attached figures, in which:

FIG. 1 shows an exemplary schematic representation of an arrangement for determining a printed circuit board identifier via a PUF unit having ring oscillators in accordance with the invention; and

FIG. 2 shows an exemplary schematic layout of delay elements of the ring oscillators of the PUF unit that are arranged on the printed circuit board in accordance with the invention.

### DETAILED DESCRIPTION OF THE EXEMPLARY EMBODIMENTS

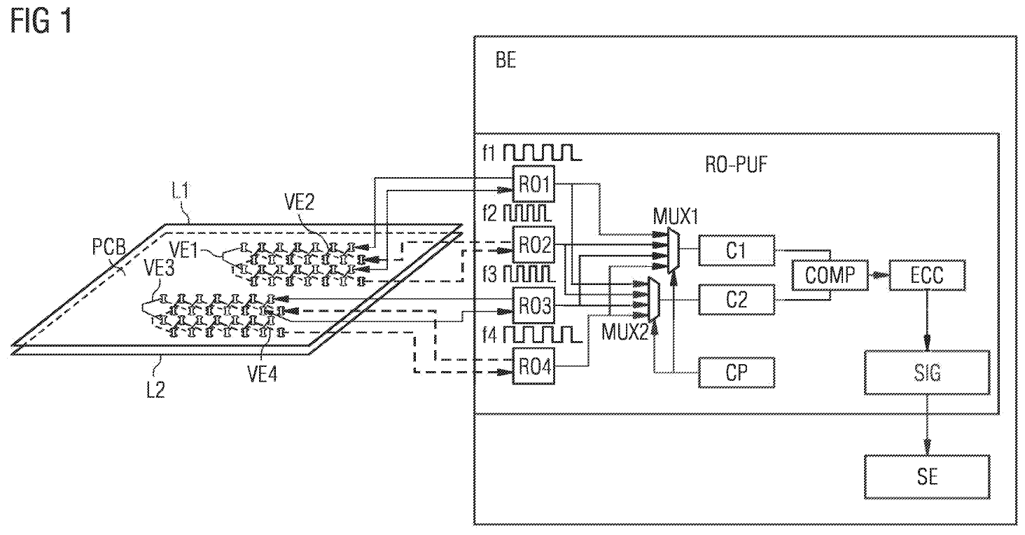

FIG. 1 shows a schematic representation of an exemplary embodiment of an arrangement for determining a unique printed circuit board identifier SIG. With the unique printed circuit board identifier, a printed circuit board PCB is permanently linked to an electronic component BE that is fitted to the printed circuit board PCB, e.g., via an assembly process, and/or soldering, and can no longer be employed in conjunction with another printed circuit board PCB, for example, for the purposes of “reverse engineering”. FIG. 1 represents an electronic component BE which is formed, for example, as an integrated circuit or an application-specific integrated circuit, or ASIC. This electronic component BE, e.g., for the construction of an electrical or electronic device, is fitted to a printed circuit board PCB, where in FIG. 1, in the interests of simplicity, the printed circuit board PCB is shown in a partial representation only. The printed circuit board PCB is configured with a multi-layered design, and comprises at least two exemplary conductive layers L1, L2, on which printed conductors can be routed via electrical connections between components BE that are fitted to the printed circuit board PCB, and that are separated by at least one insulating layer. Connection between the conductive regions or printed conductors of the various conductive layers L1, L2 of the printed circuit board PCB is provided by electrical through-contacts, or “vias”.

The arrangement in accordance with the invention comprises at least one PUF unit RO-PUF, where PUF stands for “physical unclonable functions”. The PUF unit RO-PUF is arranged in the electronic component BE or integrated in the electronic component BE. The PUF unit RO-PUF is configured as a “ring oscillator PUF unit”, and comprises an even number of ring oscillators RO1, RO2, RO3, RO4. In the interest of simplicity, four exemplary ring oscillators RO1, RO2, RO3, RO4 are represented in FIG. 4. Each ring oscillator RO1, RO2, RO3, RO4 oscillates at a natural frequency f1, f2, f3, f4, where these frequencies f1, f2, f3, f4 are approximately equal but, for reasons of production and intrinsic effects at semiconductor level, show slight variations. The unique printed circuit board identifier SIG can thus be determined by a comparing the frequencies f1, f2, f3, f4 of the ring oscillators RO1, RO2, RO3, RO4.

The arrangement further comprises delay elements VE1, VE2, VE3, VE4. The delay elements VE1, VE2, VE3, VE4 are arranged on the printed circuit board PCB, and form a respective oscillator loop for the respective ring oscillators RO1, RO2, RO3, RO4 of the PUF unit RO-PUF, where the respective oscillator loops of the ring oscillators RO1, RO2, RO3, RO4 are routed via the printed circuit board PCB. This means that a first delay element VE1 is connected via one output (e.g. an output terminal or output pin of the component BE) and via one input (e.g. an input terminal or input pin of the component BE) to a first ring oscillator RO1 of the PUF unit RO-PUF, and thus forms the oscillator loop of the first ring oscillator RO1 of the PUF unit RO-PUF. As a result, the frequency f1 or a signal from the first ring oscillator RO1 of the PUF unit RO-PUF is fed back via the first delay element VE1 to the first ring oscillator, and is influenced by the first delay element VE1. In an analogous manner, a second ring oscillator RO2 of the PUF unit RO-PUF also comprises a second delay element VE2, a third ring oscillator RO3 of the PUF unit RO-PUF comprises a third delay element VE3, and a fourth ring oscillator RO4 of the PUF unit RO-PUF comprises a fourth delay element VE4 in the respectively associated oscillator loop. As a result, the ring oscillator frequencies f1, f2, f3, f4 of the respective ring oscillators RO1, RO2, RO3, RO4 of the PUF unit RO-PUF are influenced by the respective delay element VE1, VE2, VE3, VE4, as a result of which corresponding variances occur in the ring oscillator frequencies f1, f2, f3, f4, which are associated with the printed circuit board PCB.

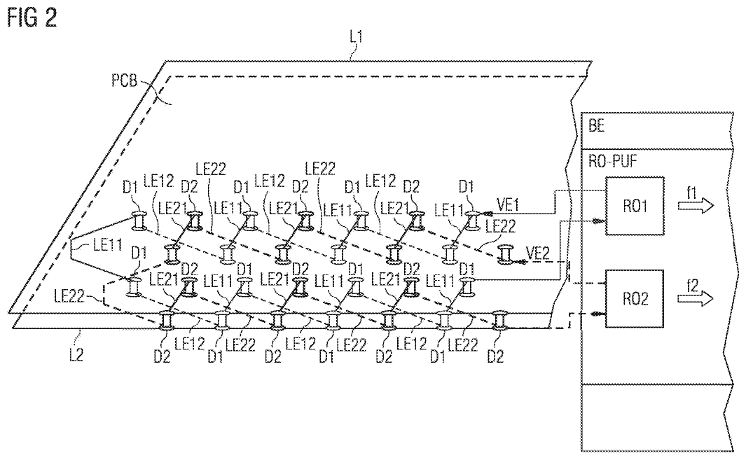

The delay elements VE1, VE2, VE3, VE4 are configured as printed conductors that are routed on the printed circuit board PCB, and are arranged in a specific layout on the printed circuit board PCB or on the conductive layers L1, L2 of the printed circuit board PCB. This specific layout is described in greater detail hereinafter with reference to FIG. 2.

FIG. 2 shows an exemplary schematic representation of the specific layout of the delay elements VE1, VE2 of the ring oscillators RO1, RO2 of the PUF unit RO-PUF that are arranged on the printed circuit board PCB, in a detailed form. FIG. 2 again represents a section of the multi-layered printed circuit board PCB, which comprises at least a first conductive layer L1 and a second conductive layer L2 (separated by an insulating printed circuit board layer). For exemplary purposes, this section of the printed circuit board PCB comprises the first delay element VE1 and the second delay element VE2.

FIG. 2 further represents a section of the electronic component BE having the PUF unit RO-PUF, or that part of the PUF unit RO-PUF having the first ring oscillator RO1, which oscillates at the first frequency f1, and the second ring oscillator RO2, which oscillates at the second frequency f2. The oscillator loop of the first ring oscillator RO1 is formed by the first delay element VE1. The oscillator loop of the second ring oscillator RO2 is formed by the second delay element VE2.

The first delay element VE1 is connected, e.g., via an input terminal and an output terminal of the electronic component BE to the first ring oscillator RO1, and is configured as a printed conductor that is routed on the printed circuit board PCB. The first delay element VE1 comprises first sections LE11, which are routed on or fitted to the first conductive layer L1 of the printed circuit board PCB, and second sections LE12 that are routed on or fitted to the second conductive layer L2 of the printed circuit board PCB. An electrically conductive connection is formed between the first sections LE11 of the first delay element VE1 that are fitted to the first printed circuit board layer L1, and the second sections LE12 of the first delay element VE1 that are fitted to the second printed circuit board layer L2, via electrical through contacts D1.

In an analogous manner to the first delay element VE1, the second delay element VE2 is also connected, e.g., via an output terminal and an input terminal of the electronic component BE to the second ring oscillator RO2. The second delay element VE2 is also configured as a printed conductor on the printed circuit board PCB. The second delay element VE2 also comprises first sections LE21 that are routed on or fitted to the first conductive layer L1 of the printed circuit board PCB, and second sections L22 that are routed on or fitted to the second conductive layer L2 of the printed circuit board PCB. The conductive connection between the first sections L21 and the second sections L22 is again formed via electrical through-contacts D2 in the printed circuit board PCB.

Moreover, the two exemplary delay elements VE1, VE2 are arranged on the printed circuit board such that the respective first sections LE11 of the first delay element VE1 overlap or intersect with the respective second sections LE22 of the second delay element VE2 at at least one point. Moreover, the respective first sections LE12 of the second delay element VE2 also overlap or intersect with the respective second sections LE12 of the first delay element VE1, i.e., each of the first sections LE11 of the first delay element VE1, at at least one point, assumes an overlap or intersection with one of the second sections LE22 of the second delay element VE2. Likewise, each of the first sections LE21 of the second delay element VE2, at at least one point, assumes an overlap or intersection with one of the second sections LE12 of the first delay element VE1. However, at the point or region of the respective overlap or intersection, there is no electrically conductive connection, or no electrically conductive contact between the two delay elements VE1, VE2, as the respective overlapping sections LE11, LE12, LE21, LE22 of the delay elements VE1, VE2 are routed on different conductive layers or strata L1, L2 of the printed circuit board PCB. This means that the respective sections LE11, LE12, LE21, LE22 of the delay elements VE1, VE2, at the point or region of overlap, for example, are arranged one above another.

Moreover, the electrical through-contacts D1, D2 employed by the delay elements VE1, VE2 are arranged in an adjacent manner on the printed circuit board. For example, adjacently arranged through-contacts D1, D2 on the printed circuit board PCB for the two delay elements VE1, VE2 can be employed such that the first sections LE11 of the first delay element VE1, which are routed on the first conductive layer L1, are substantially oriented in parallel with the first sections LE21 of the second delay element VE2 that are routed on the first conductive layer L1, and such that the second sections LE21 of the first delay element VE1, which are routed on the second conductive layer L2, assume a substantially parallel course to the second sections LE22 of the second delay element VE2 that are routed on the second conductive layer L2.

With the exemplary layout represented in FIG. 2, in which two delay elements VE1, VE2, VE3, VE4 of the arrangement are each arranged or combined on the printed circuit board PCB, the two respective delay elements VE1, VE2, VE3, VE4 respectively form a twisted printed conductor pair, which is formed on the printed circuit board PCB. Thus, in particular, the electrical through-contacts D1, D2, which are employed by the respective delay elements VE1, VE2, VE3, VE4, form a primary source for a measure of the information content or entropy for the PUF unit RO-PUF, by which the respective frequency f1, f2, f3, f4 of the respective ring oscillator RO1, RO2, RO3, RO4 of the respective delay elements VE1, VE2, VE3, VE4 is influenced in a printed circuit board-specific manner.

The ring oscillator frequencies f1, f2, f3, f4, which are influenced by the respective delay elements VE1, VE2, VE3, VE4, and thus by differences in manufacture or production, or by intrinsic effects in the printed circuit board PCB, are delivered by the respective ring oscillator RO1, RO2, RO3, RO4 (as represented in an exemplary manner in FIG. 1) as input signals, for example, to selector circuits MUX1, MUX2. As selector circuits MUX1, MUX2, for example, multiplexers MUX1, MUX2 can be employed. In each case, a ring oscillator frequency f1, f2, f3, f4 is then selected by the respective multiplexer MUX1, MUX2 and, for example, is relayed to counter units C1, C2 that, for example, evaluate rising and/or falling edges of the respective ring oscillator frequency f1, f2, f3, f4, and that relay an evaluation outcome for the respective ring oscillator frequency f1, f2, f3, f4 to a comparator unit COMP, e.g., for a pair-wise frequency comparison. Selection of the respective ring oscillator frequency f1, f2, f3, f4 by the respective multiplexer MUX1, MUX2, which is relayed to one of the counter units C1, C2 and to the comparator unit COMP, is executed, for example, by reference to a predefined input or challenge pattern CP of the ring oscillator PUF unit RO-PUF. A direct result from the comparator unit COMP, for example, from the pair-wise frequency comparison, is then delivered to an error correction circuit ECC, in order to obtain a stable printed circuit board identifier SIG. This printed circuit board identifier SIG, on the grounds of the delay elements VE1, VE2, VE3, VE4 that are arranged on the printed circuit board PCB, is unique and specific to the respective printed circuit board PCB.

The arrangement or the PUF unit RO-PUF is thus established for the initial determination of the unique printed circuit board identifier SIG, for example, during a linking phase, and for permanent saving in the electronic component BE of the unique printed circuit board identifier SIG that has been determined during this linking phase. The linking phase can be executed, for example, on a one-off basis, as an initial linking phase associated with the initial entry into service or connection of the circuit that comprises the electronic component BE. Accordingly, the initial determination of the unique printed circuit board identifier SIG and the permanent saving of the printed circuit board identifier SIG in the electronic component BE can be executed, e.g., during an initial “power-on reset” of the electronic component BE. The term “power-on reset” signifies a reset of a digital circuit or an integrated circuit that, further to the application of a supply voltage, initiates a positive start-up of the circuit, and thus of the electronic component BE, the supply voltage of the circuit has immediately achieved its rated value.

For permanent saving of the printed circuit board identifier SIG, the assembly can comprise, for example, a memory unit SE, which is at least arranged in the electronic component BE. However, the memory unit SE can also be arranged directly in the PUF unit RO-PUF. The memory unit can be configured, for example, as an arrangement of fuse link wires, into which a burn-in of the unique printed circuit board identifier determined during the initial linking phase can be executed. The printed circuit board identifier SIG is thus saved in the memory unit SE or in the electronic component BE in a one-off and permanent manner.

The memory unit SE can, moreover, be configured to be activatable for the permanent saving of the printed circuit board identifier SIG. This means that the printed circuit board identifier SIG is only permanently saved in the memory unit SE further to the activation of the latter. Prior to activation, the memory unit SE is switched to an inactive state, and the electronic component BE, or a circuit or device that is arranged on the printed circuit board PCB can be tested, e.g., in a test phase, before the printed circuit board identifier SIG is permanently saved in the electronic component BE. Only, for example, further to the completion of the test phase, can the memory unit SE, e.g., in a trusted environment (e.g., on the premises of the manufacturer), be switched to an active state and the linking phase executed, during which the printed circuit board identifier SIG is firstly determined, and is saved in the memory unit in a one-off and permanent manner. Activation of the memory unit SE can be executed, e.g., via a test interface, such as a “JTAG interface”.

The arrangement is further configured such that the unique printed circuit board identifier SIG, during routine operation, e.g., in conjunction with each power-on reset of the electronic component BE, is regenerated. The printed circuit board identifier SIG generated during the routine operation of the electronic component BE can then be compared with the printed circuit board identifier SIG that is permanently saved in the component BE. In the event of a match between the newly-generated printed circuit board identifier SIG and the printed circuit board identifier SIG that is saved in the component BE, a power-on reset, for example, can then be instructed for the remainder of the electronic circuit BE or the remainder of the integrated circuit BE. In the absence of a match, for example, a run-up of the electronic component BE can be interrupted, and any employment of the electronic component BE on a printed circuit board other than the original printed circuit board PCB can be prevented accordingly.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. An arrangement for determining a unique printed circuit board identifier, via which an electronic component which is fitted to a printed circuit board is uniquely linked to the printed circuit board, the arrangement comprising:
at least one physical unclonable functions unit having ring oscillators which, by reference to frequencies of the ring oscillators, determines the unique printed circuit board identifier, said PUF unit being arranged in the electronic component; and
delay elements which are fitted to the printed circuit board, an oscillator loop of each respective ring oscillator of the PUF unit being formed from a delay element;
wherein the delay elements are formed as printed conductors which are routed on the printed circuit board;
wherein each delay element comprises first sections which are routed on a first conductive layer of the printed circuit board, and comprises second sections which are routed on a second conductive layer of the printed circuit board;
wherein the first sections of a respective delay element which are routed on the first conductive layer of the printed circuit board and the second sections of a respective delay element which are routed on the second conductive layer of the printed circuit board are connected via electrical through-contacts; and
wherein two delay elements are each arranged on the printed circuit board such that, at at least one point, the respective first sections of the two respective delay elements overlap or intersect with the respective second sections of the two respective delay elements.

11. The arrangement as claimed in claim 10, wherein the electrical through contacts which are respectively employed by two delay elements are arranged adjacently on the printed circuit board.

12. The arrangement as claimed in claim 10, wherein the arrangement is configured to determine and permanently save the printed circuit board identifier in the electronic component during a linking phase.

13. The arrangement as claimed in claim 12, wherein the assembly is further configured such that the printed circuit board identifier is generated in a repeated manner during routine operation of the electronic component and is compared with the printed circuit board identifier which is permanently saved in the electronic component.

14. The arrangement as claimed in claim 10, further comprising:
a memory unit in which the printed circuit board identifier is permanently saved.

15. The arrangement as claimed in claim 14, wherein the memory unit is configured to be activatable to permanently save the printed circuit board identifier.

16. The arrangement as claimed in claim 15, wherein the arrangement is configured such that an activation of the memory unit to permanently save the printed circuit board identifier is executed via a test interface.

17. The assembly as claimed in claim 14, wherein the memory unit is configured as an arrangement of in-component fuse link wires.

18. The assembly as claimed in claim 15, wherein the memory unit is configured as an arrangement of in-component fuse link wires.

19. The assembly as claimed in claim 16, wherein the memory unit is configured as an arrangement of in-component fuse link wires.

20. The assembly as claimed in claim 10, wherein the electronic component comprises an application-specific integrated circuit.
